(19) United States
(12) Patent Application Publication
(10) Pub. No.: US 2009/0084405 A1
(43) Pub. Date: Apr. 2, 2009

(54) SUBSTRATE TREATING APPARATUS AND SUBSTRATE TREATING METHOD

(76) Inventors: Masahiro Kimura, Kyoto (JP); Hideaki Miyasako, Kyoto (JP); Kazuhiro Honsho, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/207,570

(22) Filed: Sep. 10, 2008

(30) Foreign Application Priority Data
Sep. 27, 2007 (JP) 2007-251378

(51) Int. Cl. B08B 7/04; B08B 13/00

(52) U.S. Cl. 134/18; 134/56 R

(57) ABSTRACT

A substrate treating apparatus for drying substrates in a solvent atmosphere after treating the substrates with a treating liquid. The apparatus includes a treating tank for storing the treating liquid, a holding mechanism for holding the substrates, the holding mechanism being movable at least between a treating position in the treating tank and a drying position above the treating tank, a chamber enclosing the treating tank, a solvent vapor supply device for supplying solvent vapor into the chamber, a concentration measuring device for measuring solvent concentration in the chamber, and an exhaust device for exhausting gas from the chamber. A controller causes the exhaust device to decompress an interior of the chamber, and causes the solvent vapor supply device to supply the solvent vapor into the chamber, after treating the substrates in the treating position in the treating tank with deionized water serving as the treating liquid. The controller also causes the exhaust device to decompress the interior of the chamber again when, with the substrates placed in the drying position, the solvent concentration has reached a predetermined value.

### BACKGROUND OF THE INVENTION

(1) Field of the Invention

This invention relates to substrate treating apparatus and substrate treating methods for treating substrates such as semiconductor wafers with a treating liquid such as deionized water, and thereafter drying the substrates in an atmosphere of organic solvent vapor.

(2) Description of the Related Art

Conventionally, a first example of apparatus of this type includes a treating tank for storing a treating liquid such as deionized water, a chamber enclosing the treating tank, a holding mechanism movable, while supporting substrates, at least between a treating position inside the treating tank and a drying position above the treating tank and inside the chamber, a solvent vapor supply nozzle for supplying vapor of an organic solvent such as isopropyl alcohol into the chamber, and a vacuum pump for decompressing the chamber interior (see Japanese Unexamined Patent Publication No. 2007-12860, for example).

With this first apparatus, after the chamber interior is decompressed while immersing the substrates in the deionized water in the treating tank, the solvent vapor is supplied in high concentration (e.g. 40%) from the solvent vapor supply nozzle into the chamber. Then, the substrates are moved to the drying position where deionized water adhering to the substrates is replaced with the solvent, thereby drying the substrates.

A second example of apparatus of this type includes a treating tank for storing a treating liquid such as deionized water, a chamber enclosing the treating tank, a drying room disposed above the treating tank and inside the chamber and shielded by an atmosphere-shielding material, a holding mechanism movable at least between a treating position inside the treating tank and the drying room, a solvent vapor supply nozzle for supplying vapor of an organic solvent into the drying room, and a vacuum pump for exhausting gas from the chamber interior (see Japanese Unexamined Patent Publication H11-186212, for example).

With this second apparatus, after moving the substrates out of the deionized water in the treating tank into the drying room, the solvent vapor is supplied in high concentration (e.g. 30%) into the drying room while exhausting gas from the chamber. As a result, the deionized water adhering to the substrates is replaced with the solvent, thereby drying the substrates.

A third example of apparatus of this type includes a chamber for receiving substrates treated with a treating liquid such as deionized water, a solvent reservoir disposed in a lower part of the chamber for storing a solvent, a heater for heating the solvent reservoir, and a holding mechanism for holding the substrates in an upper part of the chamber (see Japanese Unexamined Patent Publication H6-77203, for example).

With this third apparatus, the solvent is heated by the heater to generate a solvent vapor of high concentration (e.g. 100%) in the chamber. Thus, the deionized water adhering to the substrates held by the holding mechanism is replaced with the solvent, thereby drying the substrates.

The conventional apparatus with such constructions have the following drawback.

The conventional apparatus focus attention on how to supply a high-concentration solvent vapor, and therefore do not carry out decompression or gas exhaustion during the drying process. Consequently, when a micropattern is formed on the substrates, deionized water having entered inner parts of a deep trench structure cannot be dried completely. This can cause a problem of unsatisfactory drying performance.

### SUMMARY OF THE INVENTION

This invention has been made having regard to the state of the art noted above, and its object is to provide a substrate treating apparatus and substrate treating method free from unsatisfactory drying of substrates even when the substrates have a micropattern formed thereon.

The above object is fulfilled, according to this invention, by a substrate treating apparatus for drying substrates in a solvent atmosphere after treating the substrates with a treating liquid, the apparatus comprising a treating tank for storing the treating liquid; a holding mechanism for holding the substrates, the holding mechanism being movable at least between a treating position in the treating tank and a drying position above the treating tank; a chamber enclosing the treating tank; a solvent vapor supply device for supplying solvent vapor into the chamber; a concentration measuring device for measuring solvent concentration in the chamber; an exhaust device for exhausting gas from the chamber; and a control device for causing the exhaust device to decompress an interior of the chamber, and causing the solvent vapor supply device to supply the solvent vapor into the chamber, after treating the substrates in the treating position in the treating tank with deionized water serving as the treating liquid, and for causing the exhaust device to decompress the interior of the chamber again when, with the substrates placed in the drying position, the solvent concentration has reached a predetermined value.

The control device supplies deionized water as the treating liquid to the treating tank for treating the substrates in the treating position with the deionized water. Subsequently, the control device causes the exhaust device to decompress the interior of the chamber, and causes the solvent vapor supply device to supply solvent vapor into the chamber. As a result, although the deionized water on the surfaces of the substrates is replaced by the solvent, lid-like formations are produced on the surface of a micropattern to obstruct replacement by the solvent of the deionized water having entered deep parts of the micropattern. When, with the substrates placed in the drying position, the solvent concentration reaches a predetermined value, the control device causes the exhaust device to decompress the interior of the chamber again. This removes the lid-like formations from the surface of the micropattern, allowing the deionized water in the deep parts to be replaced by the solvent. Thus, unsatisfactory drying is avoided even if the substrates have micropatterns formed thereon.

It has been confirmed through experiment conducted by Inventors herein that, in a decompressed state, the higher solvent concentration provides the higher displacement efficiency of the solvent replacing deionized water remaining in deep parts of the micropattern. Thus, by effecting re-decompression when the solvent concentration reaches the predetermined value, the deionized water remaining in deep parts of the micropattern can be replaced by the solvent in the decompressed state with increased efficiency.

In another aspect of the invention, a substrate treating apparatus is provided for drying substrates in a solvent atmosphere after treating the substrates with a treating liquid, the apparatus comprising a treating tank for storing the treating liquid; a holding mechanism for holding the substrates, the holding mechanism being movable at least between a treating position in the treating tank and a drying position above the treating tank; a chamber enclosing the treating tank; a solvent vapor supply device for supplying solvent vapor into the chamber; a concentration measuring device for measuring solvent concentration in the chamber; a suction exhaust device disposed in the drying position for sucking and exhausting gas from around the substrates; and a control device for causing the suction exhaust device to suck and exhaust gas, and causing the solvent vapor supply device to supply the solvent vapor into the chamber, with the substrates placed in the drying position after treating the substrates in the treating position in the treating tank with deionized water serving as the treating liquid, and for causing the suction exhaust device to suck and exhaust gas again when the solvent concentration has reached a predetermined value.

The control device supplies deionized water as the treating liquid to the treating tank for treating the substrates in the treating position with the deionized water. Subsequently, with the substrates moved to the drying position, the control device causes the suction exhaust device to suck and exhaust gas, and causes the solvent vapor supply device to supply the solvent vapor into the chamber. As a result, although the deionized water on the surfaces of the substrates is replaced by the solvent, lid-like formations are produced on the surface of a micropattern to obstruct replacement by the solvent of the deionized water having entered deep parts of the micropattern. When the solvent concentration reaches a predetermined value, the control device causes the suction exhaust device to suck and exhaust gas again. This removes the lid-like formations from the surface of the micropattern, allowing the deionized water in the deep parts to be replaced by the solvent. Thus, unsatisfactory drying is avoided even if the substrates have micropatterns formed thereon.

In a further aspect of the invention, a substrate treating apparatus is provided for drying, in a solvent atmosphere, substrates treated with a treating liquid, the apparatus comprising a chamber for receiving the substrates; a holding mechanism for holding the substrates, the holding mechanism being movable at least between a standby position outside the chamber and a drying position in an upper portion of the chamber; a solvent vapor supply device disposed in a lower portion of the chamber for storing a solvent and supplying solvent vapor; a concentration measuring device for measuring solvent concentration in the chamber; a suction exhaust device disposed in the drying position for sucking and exhausting gas from around the substrates; and a control device for causing the suction exhaust device to suck and exhaust gas, and causing the solvent vapor supply device to supply the solvent vapor into the chamber, with the substrates treated with deionized water serving as the treating liquid and moved to the drying position inside the chamber, and for causing the suction exhaust device to suck and exhaust gas again when the solvent concentration has reached a predetermined value.

With the substrates treated with deionized water serving as the treating liquid and moved to the drying position inside the chamber, the control device causes the suction exhaust device to suck and exhaust gas, and causes the solvent vapor supply device to supply the solvent vapor into the chamber. As a result, although the deionized water on the surfaces of the substrates is replaced by the solvent, lid-like formations are produced on the surface of a micropattern to obstruct replacement by the solvent of the deionized water having entered deep parts of the micropattern. When the solvent concentration reaches a predetermined value, the control device causes the suction exhaust device to suck and exhaust gas again. This removes the lid-like formations from the surface of the micropattern, allowing the deionized water in the deep parts to be replaced by the solvent. Thus, unsatisfactory drying is avoided even if the substrates have micropatterns formed thereon.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus in Embodiment 1;

FIG. 2 schematically shows an experiment in dependence on isopropyl alcohol concentration of deionized water displacement efficiency, in which FIG. 2A shows a concentration at 60%, and FIG. 2B shows a concentration at 80%;

FIG. 3 is a time chart showing an example of re-decompression timing;

FIG. 4 is a flow chart of operation;

FIG. 5 is a block diagram showing an outline of a substrate treating apparatus in Embodiment 2;

FIG. 6 is a flow chart of operation;

FIG. 7 is a block diagram showing an outline of a substrate treating apparatus in Embodiment 3; and

FIG. 8 is a flow chart of operation.

### DESCRIPTION OF THE PREFERRED EMBODIMENTS

Embodiments of this invention will be described in detail hereinafter with reference to the drawings.

### Embodiment 1

Embodiment 1 of this invention will be described hereinafter with reference to the drawings.

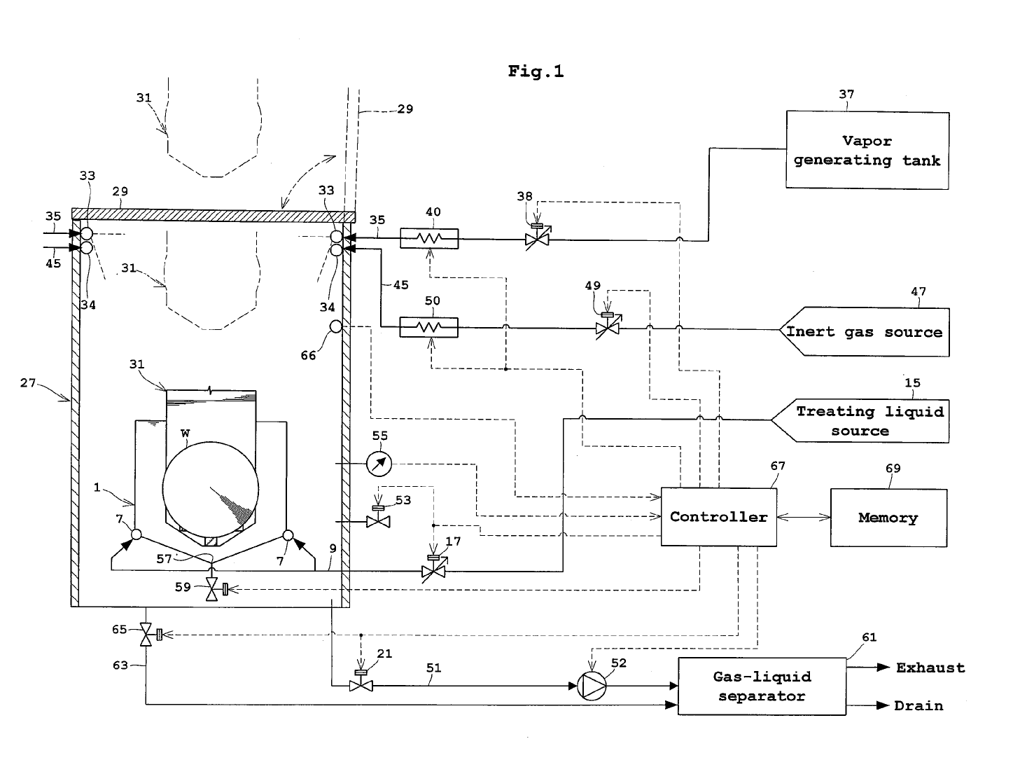

FIG. 1 is a block diagram showing an outline of a substrate treating apparatus in Embodiment 1.

The substrate treating apparatus in this embodiment includes a treating tank 1 for storing a treating liquid or solution. The treating tank 1 storing the treating liquid can receive a plurality of wafers W in upstanding posture. The treating tank 1 has two supply pipes 7 arranged in the bottom thereof for supplying the treating liquid, the supply pipes 7 having long axes extending in a direction of arrangement of the wafers W (perpendicular to the plane of FIG. 1). Each supply pipe 7 is connected to one end of piping 9. The other end of piping 9 is connected to a treating liquid source 15 which supplies, as the treating liquid, a chemical such as hydrofluoric acid or a mixture of sulfuric acid and hydrogen peroxide solution, or deionized water. Its flow rate is controlled by a treating liquid valve 17 mounted on the piping 9.

The treating tank 1 is enclosed in a chamber 27. The chamber 27 has an openable top cover 29. A lifter 31 for holding the wafers W in upstanding posture is movable by a drive mechanism, not shown, between a “standby position” above the chamber 27, a “treating position” inside the treating tank 1, and a “drying position” above the treating tank 1 and inside the chamber 27.

The above lifter 31 corresponds to the “holding mechanism” in this invention.

A pair of solvent nozzles 33 and a pair of inert gas nozzles 34 are arranged under the top cover 29 and on an upper inner wall of the chamber 27. Each solvent nozzle 33 is connected to one end of a feed pipe 35. The other end of the feed pipe 35 is connected to a vapor generating tank 37. The feed pipe 35 has, arranged thereon from upstream to downstream, a vapor valve 38 consisting of a control valve for adjusting a flow rate of solvent vapor, and an in-line heater 40 for heating the solvent vapor.

The vapor generating tank 37 generates vapor of a solvent by controlling temperature of an interior space thereof serving as a vapor generating space to a predetermined temperature. The solvent used in the vapor generating tank 37 may be isopropyl alcohol (IPA), for example. Alternatively, hydrofluoroether (HFE) may be used.

Each inert gas nozzle 34 is connected to one end of a feed pipe 45. The other end of the feed pipe 45 is connected to an inert gas source 47 for supplying an inert gas. The inert gas may be nitrogen gas (N₂), for example. The feed rate of the inert gas from the inert gas source 47 is adjusted by an inert gas valve 49 mounted on the feed pipe 45. An in-line heater 50 is mounted downstream of the inert gas valve 49. The in-line heater 50 heats the inert gas supplied from the inert gas source 47 to the feed pipe 45 to a predetermined temperature.

The chamber 27 has an exhaust pipe 51 connected thereto for discharging gas from the chamber interior through an exhaust valve 21. The exhaust pipe 51 has a vacuum pump 52 mounted thereon. A breather valve 49 consisting of a control valve is attached to the chamber 27 for canceling a decompressed state. Further, the chamber 27 has a pressure gauge 55 for detecting internal pressure.

The above vacuum pump 52 corresponds to the “exhaust device” in this invention.

The treating tank 1 has an outlet port 57 formed in the bottom thereof. The outlet port 57 has a QDR valve 59 connected thereto. When the treating solution in the treating tank 1 is discharged from the QDR valve 59, the treating solution will once be discharged to the bottom of the chamber 27. A drain pipe 63 connected to a gas-liquid separator 61 is attached to the bottom of the chamber 27. The drain pip 63 has a drain valve 65 mounted thereon. The gas-liquid separator 61 receives the gas and liquid from the exhaust pipe 51 and drain pipe 63, and separates and discharges the gas and liquid.

The chamber 27 further includes a concentration measuring unit 66 disposed in a position on the inner wall thereof for measuring concentration of the solvent in the chamber 27. The concentration measuring unit 66 stores analytical curve data for each pressure so that solvent concentration can be measured even when the interior of the chamber 27 is in a decompressed environment, and outputs concentration signals upon receipt of instructions.

The above concentration measuring unit 66 corresponds to the “concentration measuring device” in this invention.

The treating solution valve 17, exhaust valve 21, top cover 29, lifter 31, vapor generating tank 37, vapor valve 38, in-line heater 40, inert gas valve 49, in-line heater 50, vacuum pump 52, breather valve 53, QDR valve 59 and drain valve 65 noted above are operable under overall control of a controller 67 which corresponds to the “control device” in this invention. The controller 67 refers to a program stored in a memory 69 for controlling each component noted above.

The memory 69 stores also a predetermined value of solvent concentration which determines timing of re-decompression. The predetermined value of solvent concentration may be “40%”, for example.

The controller 67 supplies deionized water as treating liquid from the feed pipe 7 to the treating tank 1. After treating the wafers W in the treating position with the deionized water, the controller 57 starts decompression of the chamber 27 by operating the vacuum pump 52, while quickly draining the deionized water. The decompression is stopped upon lapse of a predetermined time. Then, the controller 67 supplies the solvent vapor from the solvent nozzles 33 into the chamber 27. The controller 67 receives concentration signals from the concentration measuring unit 66, with the wafers W having been moved to the drying position. When the solvent concentration has reached the predetermined value (40%), the controller 67 decompresses the interior of chamber 27 again by operating the vacuum pump 52. After reinstating the interior of chamber 27 at atmospheric pressure, the controller 57 opens the top cover 29 and moves the wafers W to the standby position. The above series of operations completes cleaning and drying treatment of the wafers W.

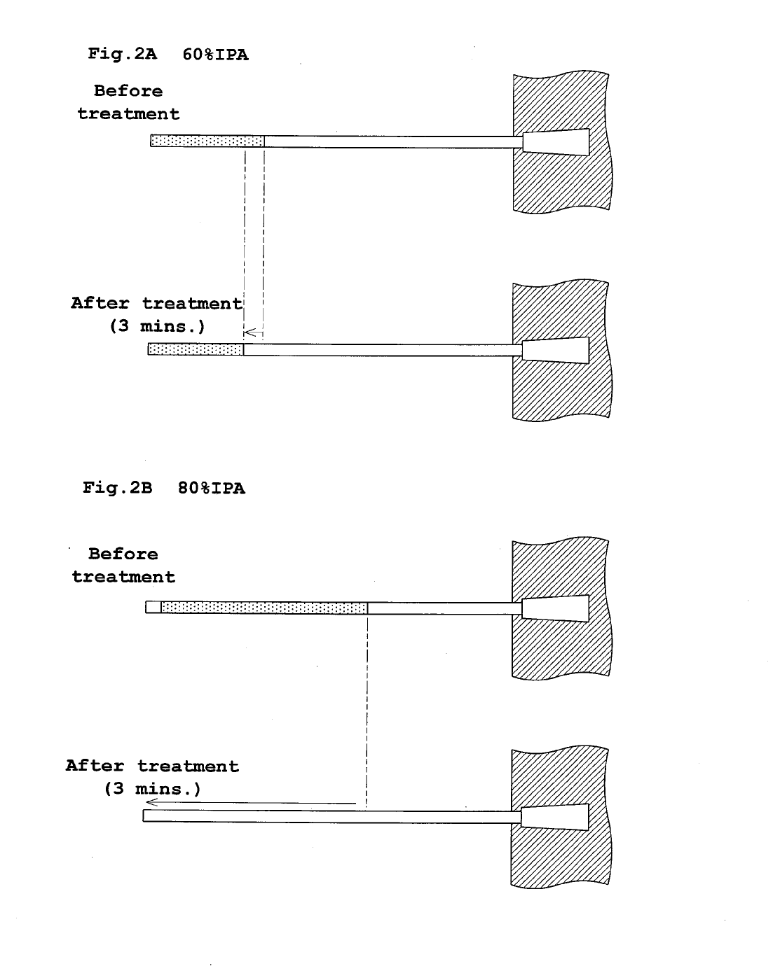

Reference is now made to FIG. 2. FIG. 2 schematically shows an experiment in dependence on isopropyl alcohol concentration of deionized water displacement efficiency. FIG. 2A shows a concentration at 60%, and FIG. 2B shows a concentration at 80%.

In this experiment, deionized water is injected into needles in order to simulate a deep trench structure as a micropattern. It has been checked what difference occurs in deionized water displacement efficiency in different solvent concentration environments under a fixed condition of decompression. FIG. 2A shows the case where isopropyl alcohol concentration is 60%. As compared with a state before treatment, only a slight replacement has taken place three minutes after the treatment. This shows low displacement efficiency.

On the other hand, FIG. 2B shows the case where isopropyl alcohol concentration is 80%. As compared with a state before treatment, all the deionized water has been replaced by isopropyl alcohol three minutes after the treatment. This clearly shows high displacement efficiency. Since it was difficult to inject deionized water in the same amount into the same position in the needles for the 60% concentration and 80% concentration, the different percentages of deionized water have resulted. However, the difference in displacement efficiency is evident.

Based on this result, the controller 67 confirms with the concentration measuring unit 66 that solvent concentration reaches the predetermined value (40%) in the decompressed environment. It has become clear from experiment conducted by Inventors herein that, when deionized water is replaced by a solvent in a decompressed environment, particularly with the deep trench structure of a micropattern on the surfaces of wafers W, there occurs a phenomenon of lid-like formations being created when the deionized water adjacent openings is replaced, whereby deionized water present in the depths remains without being replaced. Thus, the controller 67, after confirming that the solvent concentration has reached the predetermined value, removes the lid-like formations by operating the vacuum pump 52 and decompressing the interior of chamber 27 again. Consequently, the deionized water present in the depths of the micropattern is replaced by the solvent after the re-decompression. Since solvent concentration is increased, the deionized water in the depths of the micropattern is completely replaced with high displacement efficiency.

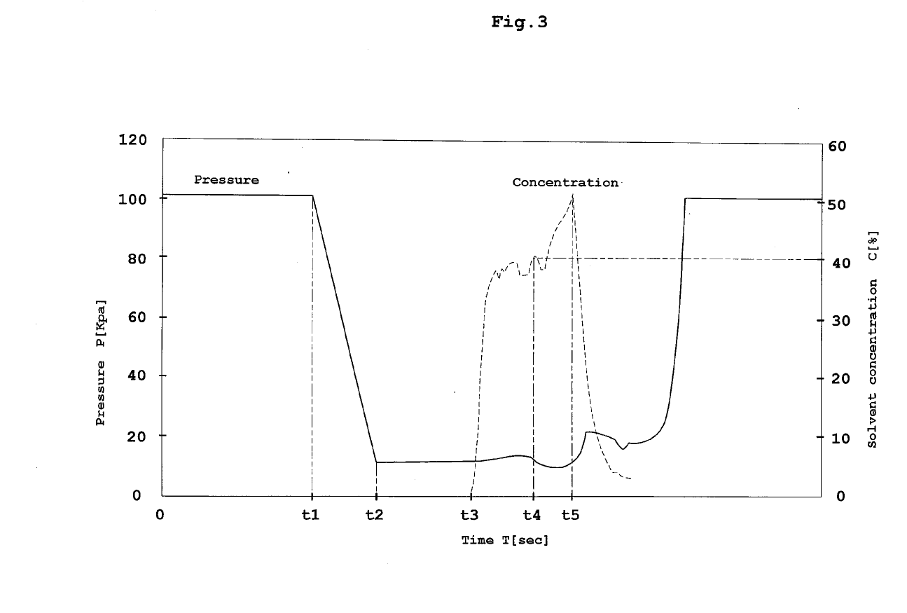

A specific control will be described with reference to FIG. 3. FIG. 3 is a time chart showing an example of re-decompression timing. In this time chart, the solid line indicates pressure while the dotted line indicates concentration.

The controller 67 operates the vacuum pump 52 at time t1 to start decompression. The decompression is stopped after the decompression is completed at a predetermined pressure at time t2. At time t3, supply of the solvent vapor is started. The vacuum pump 52 is operated again at time t4 when a concentration signal from the concentration measuring unit 66 indicates the concentration having reached 40%. Although decompression is started again, the interior of the chamber 27 has already been decompressed to a certain degree, and therefore pressure will never drop sharply. However, this re-decompression removes the lid-like formations closing the trench structure of the micropattern, thereby allowing the deionized water remaining in the depths of the trench structure to be replaced by the solvent. Subsequently, with lapse of a predetermined time, at time t5, the solvent supply is stopped and the decompression by the vacuum pump 52 is stopped. As a result, the solvent concentration in the chamber 27 lowers quickly.

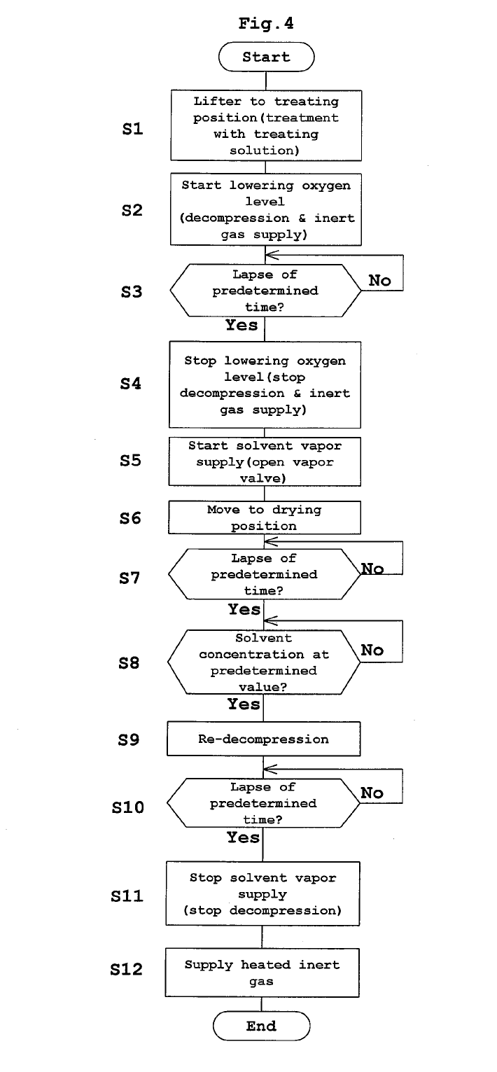

Next, operation of the above substrate treating apparatus will be described with reference to FIG. 4. FIG. 4 is a flow chart of operation.

Step S1

With deionized water stored as treating liquid in the treating tank 1, the top cover 29 is opened, the lifter 31 holding wafers W is moved to the treating position, and the top cover 29 is closed. Thus, the wafers W are cleaned with the deionized water.

Steps S2-S4

The vacuum pump 52 is operated and the inert gas valve 49 is opened to supply the inert gas from the inert gas nozzles 34 into the chamber 27 and lower the oxygen level in the chamber 27. After maintaining this state for a predetermined time, the vacuum pump 52 is stopped to stop supply of the inert gas.

Step S5

The vapor valve 38 is opened while the in-line heater 40 is operated, to supply solvent vapor from the solvent nozzles 33 into the chamber 27. From this time on, the controller 67 receives concentration signals from the concentration measuring unit 66 and monitors whether the solvent concentration reaches the predetermined value (40%).

Steps S6-S8

The lifter 31 is raised to the drying position to place the wafers W in a solvent vapor atmosphere. After lapse of a predetermined time, the operation branches according to whether the concentration signal from the concentration measuring unit 66 shows the predetermined value (40%) being reached. At this time, although the deionized water adhering to the wafers W is replaced by the solvent, the lid-like formations on the deep trench structure of the micropattern obstruct replacement by the solvent of the deionized water present in the deep parts.

Steps S9 and S10

When the solvent concentration has reached the predetermined value (40%), the controller 67 restarts the vacuum pump 52 to carry out decompression again. By reducing the pressure in the chamber 27, the lid-like formations are removed from the micropattern, allowing the deionized water in the deep parts to be replaced by the solvent. The high solvent concentration provides a high efficiency of deionized water displacement to replace the deionized water efficiently.

Steps S11 and S12

The controller 67 stops the vacuum pump 52 and closes the vapor valve 38 to stop supply of the solvent vapor. Then, the controller 67 operates the in-line heater 50 and opens the inert gas valve 49 to supply a heated inert gas into the chamber 27. The wafers W are thereby dried completely. The controller 57 opens the breather valve 53 to reinstate the interior of the chamber 27 at atmospheric pressure. This completes the cleaning and drying treatment of the wafers W.

As described above, the controller 67 supplies deionized water as treating liquid to the treating tank 1. After treating the wafers W in the treating position with the deionized water, the vacuum pump 52 is operated to decompress the interior of the chamber 27, and solvent vapor is supplied from the solvent nozzles 33 into the chamber 27. Although the deionized water on the surfaces of wafers W is thereby replaced by the solvent, the lid-like formations on the surface of the micropattern obstruct replacement by the solvent of the deionized water having entered the deep parts. When solvent concentration reaches the predetermined value, with the wafers W having moved to the drying position, the vacuum pump 52 is operated to decompress the interior of the chamber 27 again. As a result, the lid-like formations are removed from the surface of the micropattern, allowing the deionized water in the deep parts to be replaced by the solvent. Thus, unsatisfactory drying is avoided even if the wafers W have micropatterns formed thereon,

In a decompressed state, the higher solvent concentration provides the higher displacement efficiency of the solvent replacing deionized water remaining in deep parts of the micropattern. Thus, by operating the vacuum pump 52 to effect re-decompression when the solvent concentration reaches the predetermined value, the deionized water remaining in deep parts of the micropattern can be replaced by the solvent in the decompressed state with increased efficiency.

### Embodiment 2

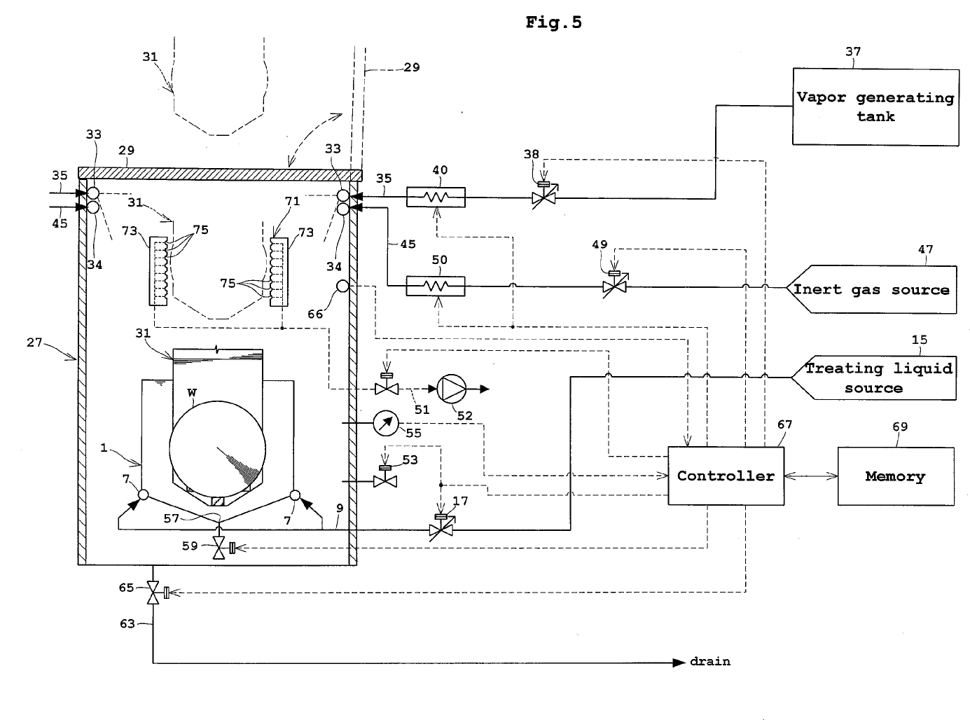

Next, Embodiment 2 of this invention will be described with reference to the drawings. FIG. 5 is a block diagram showing an outline of a substrate treating apparatus in Embodiment 2. Like reference numerals are used to identify like parts which are the same as in Embodiment 1 and will not be described again.

The apparatus in this embodiment excludes the gas-liquid separator 61 from the substrate treating apparatus in Embodiment 1 described above, with the vacuum pump 52 and exhaust pipe 51 connected to a suction exhaust mechanism 71. The suction exhaust mechanism 71 includes a pair of suction units 73 arranged at opposite sides of the drying position. Each suction unit 73 has a plurality of openings 75 opposed to the edges of wafers W.

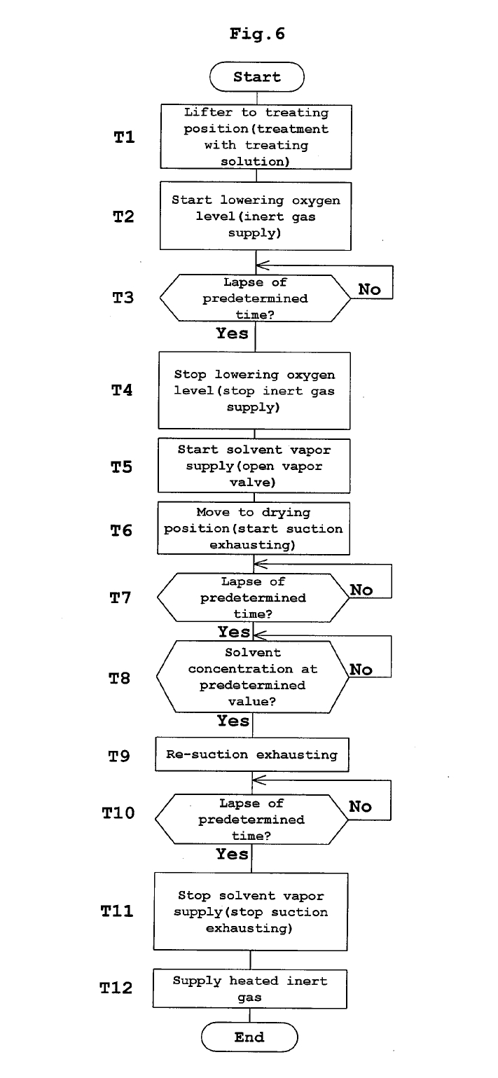

Next, operation of the above substrate treating apparatus will be described with reference to FIG. 6. FIG. 6 is a flow chart of operation.

Step T1

With deionized water stored as treating liquid in the treating tank 1, the top cover 29 is opened, the lifter 31 holding wafers W is moved to the treating position, and the top cover 29 is closed. Thus, the wafers W are cleaned with the deionized water.

Steps T2-T4

The inert gas valve 49 is opened to supply the inert gas from the inert gas nozzles 34 into the chamber 27 and lower the oxygen level in the chamber 27. After maintaining this state for a predetermined time, the supply of the inert gas is stopped.

Step T5

The vapor valve 38 is opened while the in-line heater 40 is operated, to supply solvent vapor into the chamber 27. From this time on, the controller 67 receives concentration signals from the concentration measuring unit 66 and monitors whether the solvent concentration reaches the predetermined value (40%).

Steps T6-T8

The lifter 31 is raised to the drying position to place the wafers W in a solvent vapor atmosphere. The vacuum pump 52 is operated to suck and exhaust gas from adjacent the wafers W through the suction exhaust mechanism 71. After lapse of a predetermined time, the operation branches according to whether the concentration signal from the concentration measuring unit 66 shows the predetermined value (40%) being reached. At this time, although the deionized water adhering to the wafers W is replaced by the solvent, the lid-like formations on the deep trench structure of the micropattern obstruct replacement by the solvent of the deionized water present in the deep parts.

Steps T9 and T10

When the solvent concentration has reached the predetermined value (40%), the controller 67 restarts the vacuum pump 52 to carry out suction exhaustion again. This suction exhaustion removes the lid-like formations from the micropattern, allowing the deionized water in the deep parts to be replaced by the solvent. The high solvent concentration provides a high efficiency of deionized water displacement to replace the deionized water efficiently.

Steps T11 and T12

The controller 67 stops the vacuum pump 52 and closes the vapor valve 38 to stop the supply of solvent vapor. Then, the controller 67 operates the in-line heater 50 and opens the inert gas valve 49 to supply a heated inert gas into the chamber 27. The wafers W are thereby dried completely. This completes the cleaning and drying treatment of the wafers W.

As described above, the controller 67 supplies deionized water as treating liquid to the treating tank 1. After treating the wafers W in the treating position with the deionized water, the wafers W are moved to the drying position. In this state, gas is sucked and exhausted from adjacent the wafers W through the suction exhaust mechanism 71, and solvent vapor is supplied from the solvent nozzles 33 into the chamber 27. Although the deionized water on the surfaces of wafers W is thereby replaced by the solvent, the lid-like formations on the surface of the micropattern obstruct replacement by the solvent of the deionized water having entered the deep parts. When solvent concentration reaches the predetermined value, gas is sucked and exhausted through the suction exhaust mechanism 71 again. As a result, the lid-like formations are removed from the surface of the micropattern, allowing the deionized water in the deep parts to be replaced by the solvent. Thus, unsatisfactory drying is avoided even if the wafers W have micropatterns formed thereon.

According to Embodiment 2, the suction exhaust mechanism 71 sucks gas from adjacent the edges of wafers W through the openings 75, thereby efficiently exhausting the gas from adjacent the wafers W.

Since the suction exhaustion (decompression) is carried out in the state of high solvent concentration as in Embodiment 1, the deionized water remaining in deep parts of the micropattern can be replaced by the solvent in the decompressed state with increased efficiency.

### Embodiment 3

Next, Embodiment 3 of this invention will be described with reference to the drawings.

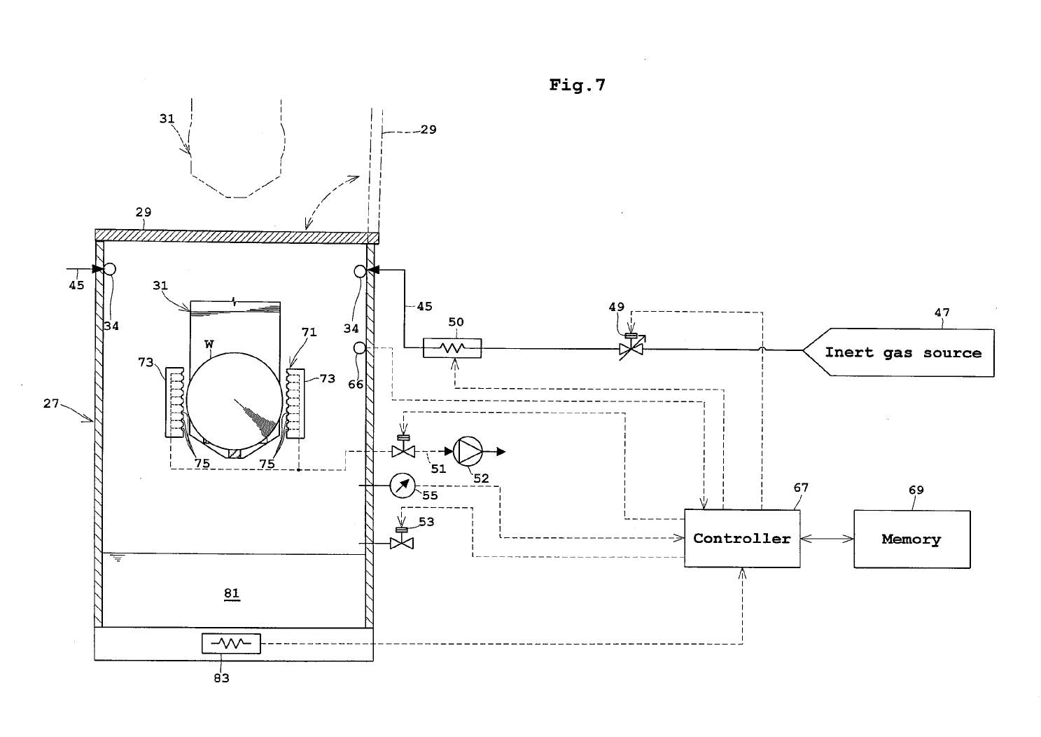

FIG. 7 is a block diagram showing an outline of a substrate treating apparatus in Embodiment 3. Like reference numerals are used to identify like parts which are the same as in Embodiments 1 and 2 and will not be described again.

The apparatus in this embodiment excludes the treating tank 1 and associated piping 9, and the vapor generating tank 37 and associated feed pipe 35 from the substrate treating apparatus in Embodiment 2 described above, and includes a solvent reservoir 81 formed in the bottom of the chamber 27, and a heater 83 mounted in the bottom of the chamber 27. Thus, as distinct from Embodiments 1 and 2, the apparatus in this embodiment is used only for drying treatment, with no treatment performed with a treating liquid.

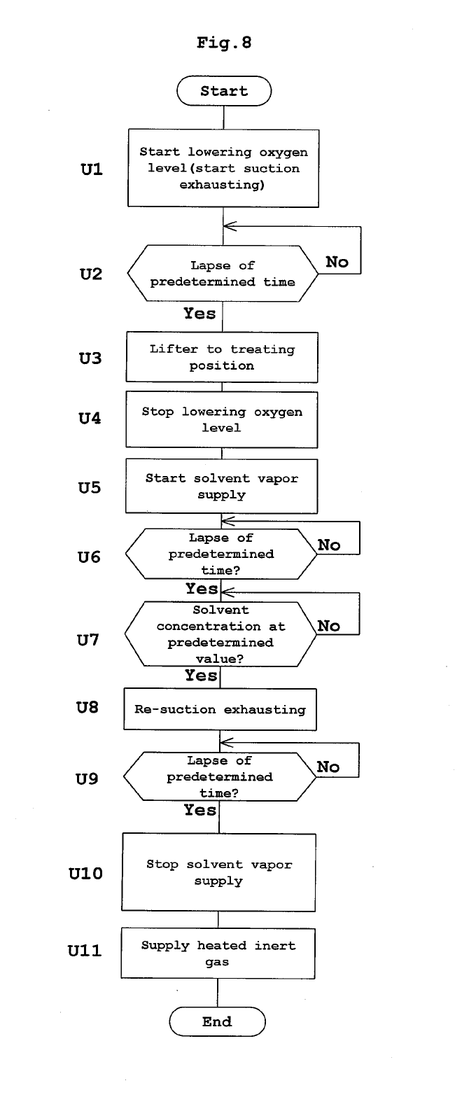

Next, operation of the above apparatus will be described with reference to FIG. 8. FIG. 8 is a flow chart of operation.

Steps U1 and U2

The inert gas valve 49 is opened to supply the inert gas into the chamber 27, and the vacuum pump 52 is operated to suck and exhaust gas from the chamber 27 through the suction exhaust mechanism 71, to lower the oxygen level in the chamber 27. After maintaining this state for a predetermined time, the operation moves to the next step U3.

Steps U3 and U4

The top cover 29 is opened, the lifter 31 holding wafers W treated with deionized water serving as treating liquid is moved to the drying position, and the top cover 29 is closed. Then, the inert gas valve 49 is closed to stop supply of the inert gas.

Steps U5 and U6

The heater 83 is operated, to supply solvent vapor into the chamber 27. From this time on, the controller 67 receives concentration signals from the concentration measuring unit 66 and monitors whether the solvent concentration reaches the predetermined value (40%). This state is maintained for a predetermined time.

Steps U7-U9

The operation branches according to whether the concentration signal from the concentration measuring unit 66 shows the predetermined value (40%) being reached. At this time, although the deionized water adhering to the wafers W is replaced by the solvent, the lid-like formations on the deep trench structure of the micropattern obstruct replacement by the solvent of the deionized water present in the deep parts. When the solvent concentration has reached the predetermined value (40%), the controller 67 restarts the vacuum pump 52 to carry out suction exhaustion again. This suction exhaustion removes the lid-like formations from the micropattern, allowing the deionized water in the deep parts to be replaced by the solvent. The high solvent concentration provides a high efficiency of deionized water displacement to replace the deionized water efficiently. This suction exhaustion is maintained for a predetermined time.

Steps U10 and U11

The controller 67 stops the vacuum pump 52 and closes the vapor valve 38 to stop supply of the solvent vapor. Then, the controller 67 operates the in-line heater 50 and opens the inert gas valve 49 to supply a heated inert gas into the chamber 27. The wafers W are thereby dried completely. This completes the drying treatment of the wafers W.

As described above, the controller 67 moves the wafers W treated with deionized water serving as treating liquid to the drying position, then causes gas to be sucked and exhausted through the suction exhaust mechanism 71. Although the deionized water on the surfaces of wafers W is thereby replaced by the solvent, the lid-like formations on the surface of the micropattern obstruct replacement by the solvent of the deionized water having entered the deep parts. When solvent concentration reaches the predetermined value, gas is sucked and exhausted through the suction exhaust mechanism 71 again. As a result, the lid-like formations are removed from the surface of the micropattern, allowing the deionized water in the deep parts to be replaced by the solvent. Thus, unsatisfactory drying is avoided even if the wafers W have micropatterns formed thereon.

Further, the suction exhaust mechanism 71 sucks gas from adjacent the edges of wafers W through the openings 75, thereby efficiently exhausting the gas from adjacent the wafers W

This invention is not limited to the foregoing embodiments, but may be modified as follows:

(1) In Embodiments 1-3 described above, the predetermined value of solvent concentration is set to 40%. The predetermined value may be above 30 to 40%, for example.

(2) In Embodiments 1 and 2, the treating tank 1 has a single tank construction. Instead, a double tank construction may be employed, which includes an inner tank, and an outer tank attached to the inner tank for collecting the treating liquid or solution overflowing the inner tank.

(3) In Embodiments 2 and 3, the suction units 73 of the suction exhaust mechanism 71 are arranged at opposite sides of the wafers W. For example, a movable suction unit 73 may be disposed below the wafers W. Further, the suction units 73 may be arranged on the side walls of the chamber 27.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for drying substrates in a solvent atmosphere after treating the substrates with a treating liquid, said apparatus comprising:
a treating tank for storing the treating liquid;
a holding mechanism for holding the substrates, said holding mechanism being movable at least between a treating position in said treating tank and a drying position above said treating tank;
a chamber enclosing said treating tank;
a solvent vapor supply device for supplying solvent vapor into said chamber;
a concentration measuring device for measuring solvent concentration in said chamber;
an exhaust device for exhausting gas from said chamber; and
a control device for causing said exhaust device to decompress an interior of said chamber, and causing said solvent vapor supply device to supply the solvent vapor into said chamber, after treating the substrates in the treating position in said treating tank with deionized water serving as the treating liquid, and for causing said exhaust device to decompress the interior of said chamber again when, with the substrates placed in the drying position, the solvent concentration has reached a predetermined value.

2. A substrate treating apparatus for drying substrates in a solvent atmosphere after treating the substrates with a treating liquid, said apparatus comprising:
a treating tank for storing the treating liquid;
a holding mechanism for holding the substrates, said holding mechanism being movable at least between a treating position in said treating tank and a drying position above said treating tank;
a chamber enclosing said treating tank;
a solvent vapor supply device for supplying solvent vapor into said chamber;
a concentration measuring device for measuring solvent concentration in said chamber;
a suction exhaust device disposed in said drying position for sucking and exhausting gas from around the substrates; and
a control device for causing said suction exhaust device to suck and exhaust gas, and causing said solvent vapor supply device to supply the solvent vapor into said chamber, with the substrates placed in the drying position after treating the substrates in the treating position in said treating tank with deionized water serving as the treating liquid, and for causing said suction exhaust device to suck and exhaust gas again when the solvent concentration has reached a predetermined value.

3. A substrate treating apparatus for drying, in a solvent atmosphere, substrates treated with a treating liquid, said apparatus comprising:
a chamber for receiving the substrates;
a holding mechanism for holding the substrates, said holding mechanism being movable at least between a standby position outside said chamber and a drying position in an upper portion of said chamber;
a solvent vapor supply device disposed in a lower portion of said chamber for storing a solvent and supplying solvent vapor;
a concentration measuring device for measuring solvent concentration in said chamber;
a suction exhaust device disposed in said drying position for sucking and exhausting gas from around the substrates; and
a control device for causing said suction exhaust device to suck and exhaust gas, and causing said solvent vapor supply device to supply the solvent vapor into said chamber, with the substrates treated with deionized water serving as the treating liquid and moved to the drying position inside the chamber, and for causing said suction exhaust device to suck and exhaust gas again when the solvent concentration has reached a predetermined value.

4. The apparatus according to claim 1, wherein said predetermined value of the solvent concentration is at least 40%.

5. The apparatus according to claim 2, wherein said predetermined value of the solvent concentration is at least 40%.

6. The apparatus according to claim 3, wherein said predetermined value of the solvent concentration is at least 40%.

7. The apparatus according to claim 2, wherein said suction exhaust device includes a suction unit having openings opposed to edges of the substrates in said drying position.

8. The apparatus according to claim 3, wherein said suction exhaust device includes a suction unit having openings opposed to edges of the substrates in said drying position.

9. A substrate treating method for drying substrates in a solvent atmosphere after treating the substrates with a treating liquid, said method comprising:
a step of treating the substrates in a treating position inside a treating tank enclosed in a chamber, with deionized water serving as the treating liquid;
a step of decompressing an interior of said chamber by operating an exhaust device for exhausting gas from the chamber, and supplying solvent vapor into the chamber by operating a solvent vapor supply device; and
a step of decompressing the interior of said chamber again by operating the exhaust device when, with the substrates placed in a drying position above the treating tank, a solvent concentration has reached a predetermined value.

10. A substrate treating method for drying substrates in a solvent atmosphere after treating the substrates with a treating liquid, said method comprising:
a step of treating the substrates in a treating position inside a treating tank enclosed in a chamber, with deionized water serving as the treating liquid;
a step of sucking and exhausting gas, with the substrates placed in a drying position above the treating tank, by operating a suction exhaust device disposed in the drying position for sucking and exhausting gas from around the substrates; and
a step of supplying solvent vapor into the chamber by operating a solvent vapor supply device and, when a solvent concentration has reached a predetermined value, sucking and exhausting gas again by operating the suction exhaust device.

11. A substrate treating method for drying, in a solvent atmosphere, substrates treated with a treating liquid, said method comprising:
a step of moving the substrates treated with deionized water serving as the treating liquid to a drying position inside a chamber;
a step of sucking and exhausting gas by operating a suction exhaust device disposed in the drying position for sucking and exhausting gas from around the substrates; and
a step of supplying solvent vapor into the chamber by operating a solvent vapor supply device disposed in a lower portion of the chamber for storing a solvent and supplying the solvent vapor, and, when a solvent concentration has reached a predetermined value, sucking and exhausting gas again by operating the suction exhaust device.

12. The method according to claim 9, wherein said predetermined value of the solvent concentration is at least 40%.

13. The method according to claim 10, wherein said predetermined value of the solvent concentration is at least 40%.

14. The method according to claim 11, wherein said predetermined value of the solvent concentration is at least 40%.

15. The method according to claim 9, further comprising a final step of supplying a heated inert gas into the chamber.

16. The method according to claim 10, further comprising a final step of supplying a heated inert gas into the chamber.

17. The method according to claim 11, further comprising a final step of supplying a heated inert gas into the chamber.
